(19) United States
(12) Patent Application Publication
(10) Pub. No.: US 2014/0299072 A1
(43) Pub. Date: Oct. 9, 2014

(54) PET COLLAR WITH ATTACHABLE DECORATIVE ELEMENT

(71) Applicant: KIM JAMES, JACKSON, TN (US)

(72) Inventor: KIM JAMES, JACKSON, TN (US)

(21) Appl. No.: 14/206,767

(22) Filed: Mar. 12, 2014

Related U.S. Application Data
(60) Provisional application No. 61/800,059, filed on Mar. 15, 2013.

(51) Int. Cl. A01K 27/00

(52) U.S. Cl. CPC A01K 27/006; A01K 27/001
USPC 119/856

(57) ABSTRACT

A pet collar with one or more decorative elements that can be repeatedly attached and detached from the collar. The means for attachment may comprise Velcro, snaps, ties, or other similar devices. The pet collar may be of any size and shape, and the size and shape of the decorative element may change to match the collar size and shape. Multiple decorative elements may be attached to a collar. The decorative elements may be made of cloth, fabric, leather, polyester, metal, other suitable material, or combinations thereof.

This application claims benefit of and priority to U.S. Provisional Application No. 61/800,059, filed Mar. 15, 2013, by Kim James, and is entitled to that filing date for priority. The specification, figures and complete disclosure of U.S. Provisional Application No. 61/800,059 are incorporated herein by specific reference for all purposes.

### FIELD OF INVENTION

This invention relates to a collar for a pet with a plurality of decorative elements that can be attached and detached.

### SUMMARY OF INVENTION

In various embodiments, the present invention comprises a collar, such as a pet or animal collar (which include, but are not limited to, dog collars and cat collars) with one or more decorative elements that can be repeatedly attached and detached from the collar. The means for attachment may comprise Velcro, snaps, ties, or other similar devices. The pet collar may be of any size and shape known in the art, and the size and shape of the decorative element may change to match the collar size and shape.

Multiple decorative elements may be attached to a collar. Decorative elements may comprise plain, patterned or colored strips, ribbons, bangles, bells, buttons, studs, trims, or other forms of decoration. The decorative elements may be made of cloth, fabric, leather, polyester, metal, other suitable material, or combinations thereof.

### DESCRIPTION OF THE DRAWINGS

FIG. 1 shows a view of a collar with a decorative element in accordance with an embodiment of the present invention.

### DETAILED DESCRIPTION OF EXEMPLARY EMBODIMENTS

In various exemplary embodiments, the present invention comprises a collar, including but not limited to a animal or pet collar (which include, but are not limited to, dog collars and cat collars) with one or more decorative elements that can be repeatedly attached and detached from the collar. The means for attachment may comprise Velcro (hook-and-loop fasteners), snaps, ties, or other similar devices. The pet collar may be of any size and shape known in the art, and the size and shape of the decorative element may change to match the collar size and shape.

Multiple decorative elements may be attached to a collar. Decorative elements may comprise plain, patterned or colored strips, ribbons, bangles, bells, buttons, studs, trims, or other forms of decoration. The decorative elements may be made of cloth, fabric, leather, polyester, metal, plastic, other suitable material, or combinations thereof.

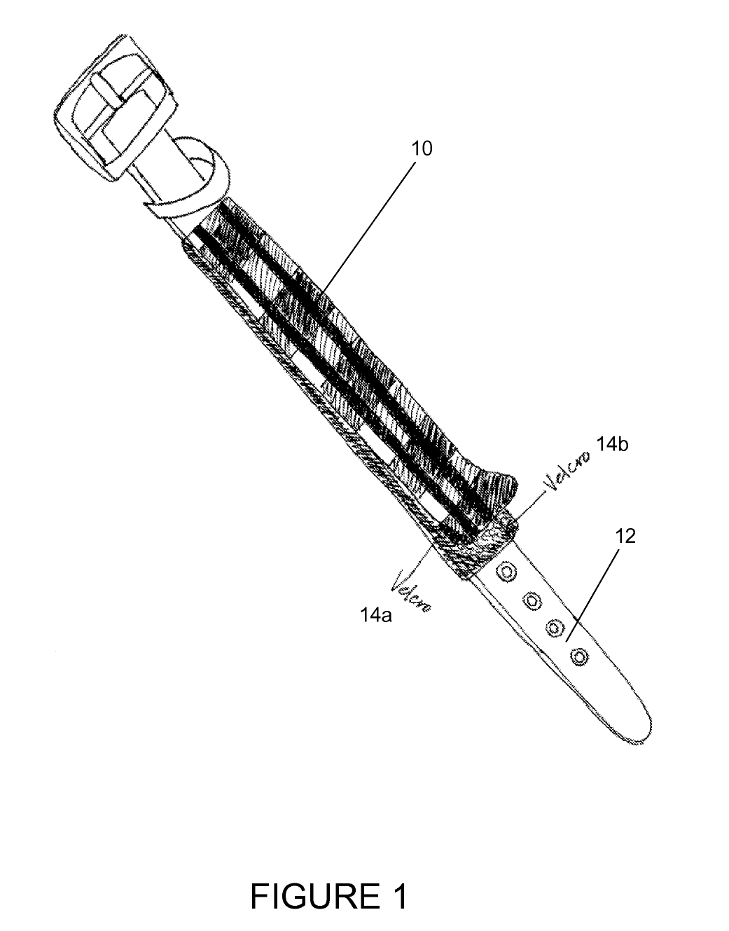

In the exemplary embodiment shown in FIG. 1, a patterned cloth decorative element 10 is removably affixed to dog collar 12 by means of Velcro strips 14a, b. One strip of Velcro is permanently affixed to the collar (by sewing, gluing, or other forms of adhesion or affixation), while the other matching strip of Velcro is permanently affixed to the back of the decorative element (by similar means). In one embodiment, the Velcro (or other attachment means) may be an integral component of the collar or decorative element, or both.

In one exemplary embodiment, the soft (or fuzzy) Velcro strip is affixed to the collar so that the collar can be used without a decorative element, and the stiff loop Velcro strip is affixed to the decorative elements. In an alternative embodiment, the strips may be switched.

Accordingly, the user can alternatively attach and detach a variety of decorative elements to the pet collar to change the look of the collar as desired.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A device, comprising:
a collar with an inside and outside, said outside comprising one or more first attachment elements;
one or more decorative elements, each decorative element comprising a second attachment element adapted to removably attach to one or more of said first attachment elements.

2. The device of claim 1, wherein the collar is a pet or animal collar.

3. The device of claim 1, wherein the collar is a dog collar.

4. The device of claim 1, wherein the collar is a cat collar.

5. The device of claim 1, wherein the first attachment element is a strip of loop fasteners, and the second attachment element is a strip of hook fasteners.

6. The device of claim 1, wherein said one or more first and second attachment elements comprise a snap.

7. The device of claim 1, wherein the one or more decorative elements may vary in size.

8. The device of claim 1, wherein the one or more decorative elements are made of cloth, fabric, leather, polyester, metal, plastic, or combinations thereof.

9. The device of claim 1, wherein the one or more decorative elements comprise a plain, patterned or colored strip.

10. A device, comprising:
a collar with an inside and outside, said outside comprising one or more first attachment elements;
one or more decorative elements, each decorative element comprising a second attachment element adapted to removably attach to one or more of said first attachment elements.
